(19) United States
(12) Patent Application Publication
(10) Pub. No.: US 2025/0315593 A1
(43) Pub. Date: Oct. 9, 2025

(54) MARKING TECHNIQUES USING UNIQUE FONT FILE VERSIONS FOR DOCUMENT SOURCE DETECTION

(71) Applicant: EchoMark, Inc., Kirkland, WA (US)

(72) Inventors: Colin SAUNDERS, San Francisco, CA (US); Sanjay KRISHNAN, Hinsdale, IL (US)

(21) Appl. No.: 18/629,581

(22) Filed: Apr. 8, 2024

(51) Int. Cl. G06F 40/109; G06F 16/901; G06F 40/143

(52) U.S. Cl. CPC G06F 40/109; G06F 16/9014; G06F 40/143

(57) ABSTRACT

For document source detection, text having a specific spacing pattern is rendered from unique versions of font files that identify an individual or device. If a document is leaked, and an artifact of it is recovered, the spacing pattern in the artifact can be used to determine the source of the document to identify the potential leak. To do so, unique string is generated for a user. The unique string is hashed, and font tables are modified to generate the unique font file version using the hash value. When text is generated using the unique font file version, glyph spacing is adjusted slightly according to the modified font table. A text classifier can be used to classify the relative spacing of glyphs in an artifact, and from values assigned by the classifier, a data sequence is determined. The data sequence is compared to hash values to identify the source.

### BACKGROUND

Document source detection discourages people from leaking sensitive information, while at the same time, it can identify individuals responsible for leaks if a leak does occur. Historically, detecting the source of a leaked document involved a multifaceted approach that included digital forensics, analysis of document metadata, and network logs to trace back to the origin of the leak. This process would often require collaboration between information technology (IT) security teams, legal advisors, and sometimes external cybersecurity experts to ensure a thorough investigation, to identify the individual or group responsible for the leak.

### SUMMARY

At a high level, aspects herein relate to document source detection using unique fonts. For example, a unique version of a font that encodes a letter-spacing pattern within text can be generated for an individual or device. Thus, when a user creates text using the unique font file version specific to that user, the text generated includes a spacing pattern that is difficult to detect with the naked eye and can be used to identify the individual should a document having the text be leaked.

To generate a unique font file version for a font type, a unique string specific to an individual or device is generated. The unique string is hashed to generate a hash value, which can include a sequence of binary digits.

A font file can then be modified according to the hash value. One common font file format is the TrueType, or “.ttf”, format. This font file type includes various font tables in the file that determine the characteristics of each glyph (e.g., a letter) when rendered, such as its height and width, and its spacing from other glyphs. Accordingly, these tables are modified so that there is an adjustment to the glyph spacing, including adjustments to the glyphs or spacing between glyphs, when rendered. The table can be modified, for instance, to increase or decrease glyph spacing. The hash value is used to determine what type of adjustment each glyph receives, thereby creating a unique spacing pattern that will be imparted into text rendered using the modified font table. Since each hash value that is unique, each modified font table is also unique, thereby generating a unique version of the font file specific to the individual or device. When the unique font file version is used to render text, the text includes a spacing pattern that is determined by the hash values and the corresponding modifications to the font table.

If a document having this spacing pattern is leaked, the spacing pattern can be used to identify the source of the leak. For instance, a recovered artifact can be provided to a text classifier that classifies the relative sizes of glyphs, such as whether the relative sizes are smaller or larger than they otherwise would be for a particular font. The classified text is assigned a value, and the values may be used to generate a data sequence, e.g., a sequence of 1s and 0s that is representative of the spacing pattern. The data sequence can be compared to the hash values that correspond to different sources, thereby identifying a source that corresponds to a matching hash value.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment suitable for implementing aspects of the described technology, in accordance with an aspect described herein;

FIG. 2 illustrates an example overview process for document source detection using unique font file versions, in accordance with an aspect described herein;

FIG. 3 illustrates an example hash value generation from unique strings as part of generating unique font file versions, in accordance with an aspect described herein;

FIG. 4 illustrates an example source index that may be used for unique font file version generation and source detection, in accordance with an aspect described herein;

FIG. 5 illustrates an example in which a unique font file version is generated from a font file, in accordance with an aspect described herein;

FIG. 6 illustrates some example glyph spacing adjustments that may be rendered from a unique font file version, in accordance with an aspect described herein;

FIG. 7A-FIG. 7C illustrate an example source detection from an artifact, in accordance with an aspect described herein;

FIG. 8 illustrates an example in which training data is generated to train a text classifier for document source detection, in accordance with an aspect described herein;

FIG. 9 illustrates an example in which a markup language is modified so that text rendered from the markup language includes a spacing pattern generated from a unique font file version, in accordance with an aspect described herein;

FIG. 10 illustrates a flowchart having an example method for generating a unique font file version that can be used to render a spacing pattern with text generated from the unique font file version for document source detection, in accordance with an aspect described herein;

FIG. 11 illustrates a flowchart having an example method for modifying a markup language such that text generating from the markup language includes a spacing pattern from a unique font file version for document source detection, in accordance with an aspect described herein;

FIG. 12 illustrates a flowchart having an example method for training a text classifier used in document source detection, in accordance with an aspect described herein;

FIG. 13 illustrates a flowchart having an example method for determining the source of an artifact created from text encoded with a spacing pattern by a unique font file version, in accordance with an aspect described herein;

FIG. 14 illustrates a flowchart having an example method for rendering text having a spacing pattern determined from a unique font file version, in accordance with an aspect described herein; and

FIG. 15 illustrates an example computing device that may perform aspects of the present technology, in accordance with an aspect described herein.

### DETAILED DESCRIPTION

Confidential documents are critical assets for many organizations, encompassing a wide range of sensitive information, including trade secrets, business strategies, financial records, and personal data of employees or clients. These documents are often restricted to a select group of individuals within the organization to safeguard their content from unauthorized access and potential misuse. One of the main goals in maintaining the confidentiality of this information is to prevent competitive disadvantage, legal liabilities, reputational damage, or other forms of harm that could arise from their unauthorized disclosure.

Typically, organizations implement various measures to protect confidential documents, including physical security controls (e.g., locked cabinets, access-controlled rooms, etc.), digital security measures (e.g., encryption, access controls, and authentication mechanisms), and administrative policies (e.g., confidentiality agreements, employee training on data handling protocols, etc.). Despite these efforts, the risk of malicious leaks remains a significant concern, as insiders with legitimate access or external attackers who have gained unauthorized access can distribute confidential documents.

When an artifact of a leaked document is recovered, identifying the source presents several technical and investigative challenges. For instance, documents distributed digitally often contain metadata or hidden data that could potentially help trace their origin. However, malicious actors may alter or remove this metadata to obscure their tracks. Additionally, organizations may employ watermarking or digital fingerprinting techniques to embed unique identifiers into documents as a means to track them. Despite these efforts, if the watermarking or fingerprinting methods are not sophisticated enough, they might not withstand attempts by leakers to remove or alter these identifiers, thereby complicating the tracing process.

Another significant hurdle is the widespread distribution of leaked documents across multiple platforms. Once a document is leaked online, it can be rapidly shared and disseminated across various websites and social media, leading to a proliferation of copies. This vast distribution makes it difficult to trace the original source of the leak among potentially thousands of copies.

Moreover, when a leaked document is not in its original format, such as when a photo or copy of a document has been distributed, determining the source becomes even more complex. This alteration can strip away many of the digital fingerprints or metadata that might have been used to trace the document back to its origin. Photos or scans of a document may lack the embedded digital information that original digital documents possess, further complicating the identification of the source.

While digital signatures, including watermarking and fingerprinting techniques, are designed to uniquely identify and protect the confidentiality of documents, often, the effectiveness of these methods often hinges on the integrity and completeness of the artifact. For some existing technologies to match an artifact to its source copy, the artifact must be nearly intact and undistorted. This requirement presents significant challenges when the artifact recovered is only a small portion of the original document or has undergone modifications such as resizing, cropping, or conversion into a different format. Such alterations can obscure the embedded digital fingerprints or watermarks, hampering efforts to confidently identify the source with statistical confidence.

Another notable limitation of some existing document detection techniques lies in their approach to storing individual copies of each marked document. This method can consume considerable amounts of storage space, posing a logistical and economic challenge for organizations managing a large volume of confidential documents. Furthermore, many of these techniques are designed to mark only the final version of a document. They lack the capability to dynamically mark drafts and text throughout the drafting process. This limitation restricts the ability to trace the lineage of leaks that may occur at various stages of document development.

The technology provided in this disclosure helps solve problems inherent in some prior document source detection techniques. One example method that will be more fully described generates a unique version of a font that embeds a unique spacing pattern when generating or rendering a document. This can be done by modifying a font file to generate a unique font file version of a font for an individual or device. When the unique font file version is used to create or render text, the spacing of and between various glyphs is adjusted according to the modifications made in the unique font file version, thus embedding a particular spacing pattern that identifies the source of the rendered document.

To generate a unique font file version that embeds a traceable spacing pattern, unique strings of characters can be generated for specific individuals or devices. That is, if Alice works for ABC, Corp., a unique string specific to Alice might be “ABC_corp_Alice_font name.” Each string can be specific to a device or individual. The unique string is hashed to generate a hash value. Hashing algorithms, such as SHA-256, can be used and often generate a sequence of binary digits, such as 0s and 1s. Provided the unique strings are each different, the hashing algorithm is likely to generate a different hash value for each unique string, thereby generating a different hash value for each individual or device.

The generated hash values can be used to modify a font file that is used to render text in accordance with a particular font. In general, font files include font tables that instruct a computing device how to render glyphs for that particular font. For example, a common font file format is the TrueType format, “.ttf.” In the TrueType format, each glyph is represented as an SVG (scalable vector graphics) file and the spacing of and between glyphs is adjusted through a variety of spacing tables. By modifying these tables, the glyph spacing can be adjusted when text is rendered. The font tables for a font can be modified according to the hash value to generate a unique font file version of that font. For instance, the 1s and 0s in the hash value may correspond to an increase and decrease in a particular glyph's spacing. Using a simplified example, a hash value of 0110 could be used to modify a font table so that a's have a reduced glyph width, b's have an increased glyph width, c's have an increased glyph width, and d's have a reduced glyph width. Various aspects of the glyph spacing may be modified, such as the width or height of the overall glyph, or a width or height of a particular feature of a glyph, including spacing between specific pairs of glyphs, sometimes referred to as kerning or kerning adjustments.

In this manner, each unique font file version corresponds to a device or individual and generates a different spacing pattern within the text. As such, the unique font file version can be used to generate text within a document and render text on a display, whether using a document editor, browser, or other program. In doing so, unique font file version imparts a spacing pattern that can be used to identify a source of the document in the event of a leak.

If a leak does occur, and an artifact is recovered, then the spacing pattern in the artifact can be used to identify the source. To do so, the text of the artifact is provided to a trained text classifier that classifies the glyph spacing, such as whether a particular glyph is relatively larger or smaller than it otherwise would be. Based on the classification, the text classifier assigns a value to the relative spacing. The values provided by the text classifier can be included as part of a data sequence and compared to the hash values generated from the unique strings. From the comparison, a source of the document can be determined for a recovered artifact.

Embedding spacing patterns in documents for source identification using unique font file versions provides multiple technical advancements to existing document source detection techniques, and also solves various technical problems and challenges inherent in them.

For example, unlike some existing document source detection methods, methods described herein may not require individual changes made to an original document. For instance, an original document can be generated, and the changes may be applied as the document is accessed by other individuals. The font of the original document can be modified using a unique font file version as the document is accessed. For example, a document can be generated and placed on a file share or other accessible storage location. When the document is accessed by another device, a version of the document is rendered with a spacing pattern using a unique font file version that is accessed by the device. Thus, as the document is accessed, it includes the changes to the spacing pattern based on the device accessing it. If this version of the document is leaked, the leak can be traced back to the accessing device based on the spacing pattern. Moreover, in some aspects, the device may access the document more than once, but each time the document is rendered with the same spacing pattern based on the same unique font file version is used for the rendering. Overall, this helps limit the number of unique copies of a document that get generated, which makes it easier to detect the source when leaked compared to existing methods that might generate multiple unique copies of an original document each time it is accessed, even when accessed by the same machine.

Another advantageous feature of the present technology is that change to the document may, in some cases, be made at the device accessing the document. Thus, even if a document is stored locally at a device, then the spacing pattern may be imparted to the document when accessed by the device using the unique font file version used by the device to generate the text of the document. This is beneficial because it does not necessarily require the originator of the document to have specialized software to create a watermarking in the original when it is generated or sent. Instead, any document being accessed by a device might be rendered with a spacing pattern unique to that device, regardless of whether the original document includes any unique changes. This is particularly beneficial when an artifact might contain text from additional documents, which an original author did not individually modify. This departs from and provides advancements over existing document source detection techniques that detect changes made directly to an original document, expanding the number and types of documents within an artifact that might be used to determine an original source.

Further, document source detection techniques provided herein may allow source detection without storing unique copies of an original document. As noted, some existing techniques store unique copies of an original, which can be used for artifact matching when determining the source. However, aspects of the present technology match artifacts to hash values. This allows storage of hash value mappings to a source as opposed to storing documents, significantly reducing storage space. This also further increases security of the information, since the information contained in a document is not determinable from the hash value, even if the hash value were inappropriately accessed. Moreover, since hashing algorithms may provide a generally consistent hash value for each input, hash values do not necessarily need to be stored for each individual or device, as they can be regenerated whenever needed. As such, these techniques reduce the number of documents that need to be stored for source detection and improve the security of the information within the documents.

Yet another advancement provided by the described technology provides for the ability to render text with unique spacing patterns from markup languages. Some existing document source detection methods apply changes to a document when originally generated. This makes it difficult to apply individual changes to markup languages, as different devices reading the markup languages would render the text in the same way. However, the present disclosure may modify a markup language so that the device renders text from the markup language in a manner that includes a unique spacing pattern. Thus, the originator of the markup language can generate one code that can be rendered differently by different devices according to each device's unique font file version.

Further still, the present technology provides aspects that impart modifications to text as the text is being generated, which provides additional benefits over some existing document source detection techniques. As noted, some prior techniques watermarked final documents, as the watermarking techniques were dependent on the full document contents. However, since the present technology generates text from a unique font file version, the adjustments to the individual glyphs are created at the time the text is generated, thus allowing changes to be made to a document or text that is not in a final form. Other technical improvements and advancements over existing watermarking and detection techniques will be realized by those having skill in the art and by practice of the technology.

It will be realized that the methods previously described are only examples that can be practiced from the description that follows, and the examples are provided to more easily understand the technology and recognize its benefits. Additional examples are now described with reference to the figures.

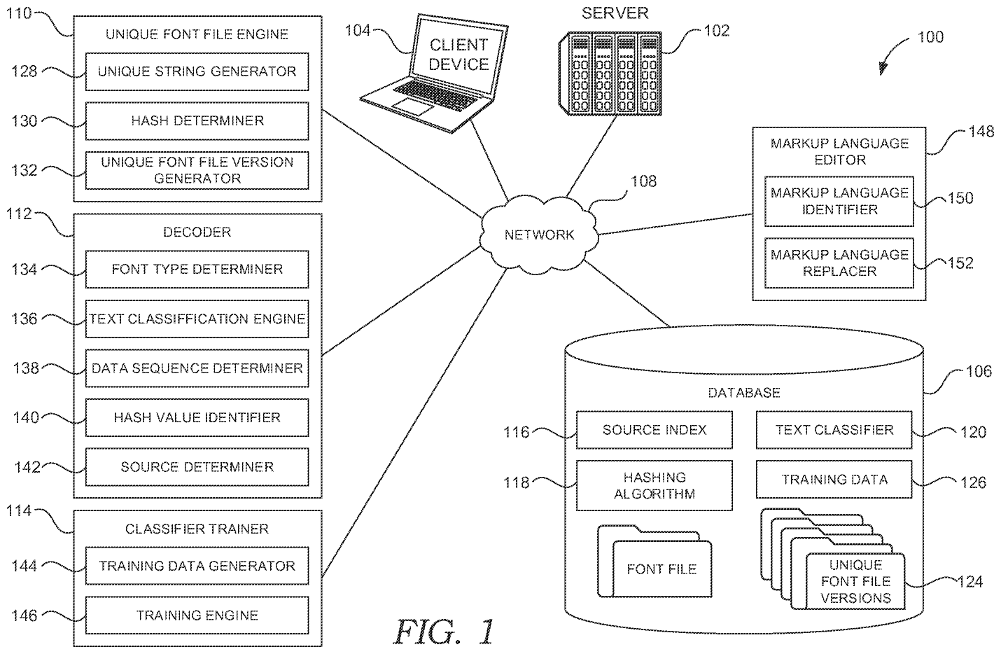

With reference now to FIG. 1, an example operating environment 100 suitable for document source detection using unique font versions is provided. Components of FIG. 1 may render text having unique spacing patterns that can be used to identify a source if a document is leaked. At a high level, components of FIG. 1 may generate a unique font file version for an individual or device using unique font file engine 110. The unique font file version is used to render text having a unique spacing pattern that can be identified by decoder 112 and used to determine the source of a document if an artifact is recovered from a leak.

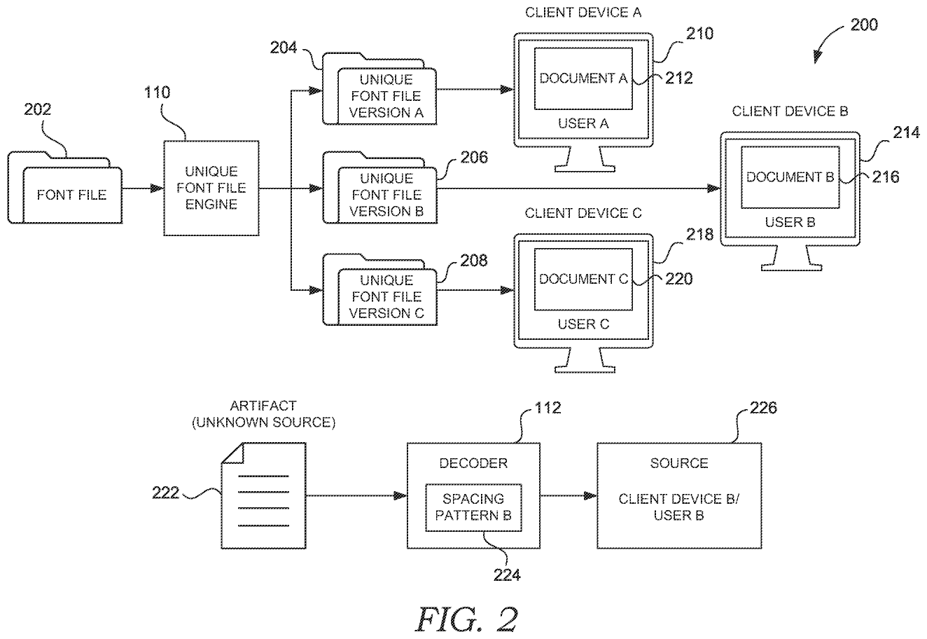

FIG. 2 provides a general example overview process 200 in which a source of a document is determined using unique font file engine 110 and decoder 112. In this example unique font file engine 110 is used to generate unique font file versions of font file 202, each of which can be used to render a document having a different spacing pattern corresponding to a different source. If a document is leaked by way of a recovered artifact 222, decoder 112 can be used to determine the unique spacing pattern in artifact 222, and from it, identify the source of the leaked document. As noted, FIG. 2 is intended to provide one example to aid in describing and understanding the technology, aspects of which will be discussed in future detail with reference to additional figures.

In this example, unique font file engine 110 is initially used to create different font file versions from font file 202. While illustrated as creating three unique font file versions—unique font file version A 204, unique font file version B 206, and unique font file version C 208—any number of unique font file versions may be created. Each unique font file version may be created for a specific individual or device, and thus, text rendered by the individual or device using the respective unique font file version will have a spacing pattern that identifies the individual or device. As illustrated in the example, unique font file version A 204 is used by client device A 210 to render document A 212. Likewise, unique font file version B 206 is used by client device B 214 to render document B 216, and unique font file version C 208 is used by client device C 218 to render document C 220. Thus, while the textual contents of document A 212, document B 216, and document C 220 may appear the same to the naked eye, each may contain a different spacing pattern generated by the respective unique font file version that can be identified by decoder 112 and used to determine the source of the rendered document, e.g., user A, user B, or user C.

Artifact 222 may be in the same or different format as the rendered document, and it may be all or a portion of the rendered document. In general, artifact 222 is a recovered object comprising text from a rendered document using a unique font file version, thus having a specific spacing pattern corresponding to the unique font file version. In the illustrated example, decoder 112 identifies a spacing pattern B 224 which corresponds to the spacing pattern that is generated using unique font file version B 206. Thus, artifact 222 is an artifact of document B 216. Knowing this, a possible source 226 of the leak is identified as user B, since document B 216 was rendered using client device B 214.

Turning back to FIG. 1, to generate a unique font file version, unique font file engine 110 may employ unique string generator 128, hash determiner 130, and unique font file version generator 132. In aspects, unique font file engine 110 generates a unique font file version from a font file for an individual or device. For example, a unique font file version may be generated for an individual and associated with a user account. Thus, when an individual is identified by the user account, the unique font file version can be used to render text corresponding to the user account. In another aspect, a unique font file version is generated for a device. That is, a specific device may be identified and provided access, either through a local storage address or a remote storage address, to a unique font file version so that the device renders text having a spacing pattern defined by the unique font file version. Unique font file engine 110 may generate a unique font file version for a combination of individuals and devices, and may generate a unique font file version for a group of individuals or devices such that text generated using the unique font file version identifies the group.

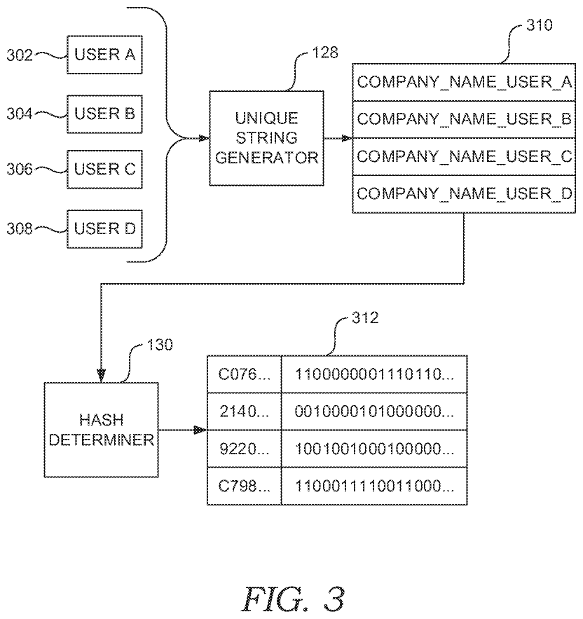

FIG. 3-FIG. 5 illustrate examples in which components of unique font file engine 110 are employed to generate a unique font file version for rendering text with a specified spacing pattern that can be used for source detection by decoder 112. At a high level, a unique string generator 128 may generate a unique string that is accessed and hashed by hashing algorithm 118 using hash determiner 130. Unique font file version generator 132 generates a unique font file version of a font file using the hash value.

To illustrate, FIG. 3 depicts an example in which hash values are determined for generating unique font file versions. Here, unique string generator 128 generates unique strings 310 for a set of users comprising user A 302, user B 304, user C 306, and user D 308. While illustrated as generating four unique font file versions for four users, it will be understood that unique string generator 128 may generate a unique string for any number of users. Moreover, users A-D, 302-308 in this context, may be representative of specific individual accounts or particular devices.

Unique string generator 128 may generate a unique string comprising any type and number of characters. Unique string generator 128 can generate a different unique string for each user, e.g., a different unique string of characters for each individual or device. In aspects, a unique string is generated using a specific pattern of information, such that the unique string may be replicated, if needed, to regenerate or substantially reaerate the hash value. To provide an example, a unique string may include a company name, user name, font type, or other like information. It will be appreciated that any information may be used in any order. Using a previous example, if Alice works for ABC, Corp., a unique string specific to Alice might be “ABC_corp_Alice_font name.” Likewise, if Bob also works for ABC, Corp., a unique string specific to Alice might be “ABC_corp_Bob_font name.”

As illustrated in FIG. 3, hash determiner 130 may be employed to generate hash values 312 from unique strings 310. Hash values may be represented in various forms, including a sequence of binary digits, a hex digest, or the like. A hash value may be generated for each respective unique string of unique strings 310.

Referring back to FIG. 1, hash determiner 130 may use hashing algorithm 118 to generate a hash value from a unique string. Various different hashing algorithms may be used and provided as hashing algorithm 118. Examples include MD5 (Message Digest Algorithm 5); SHA-1 (Secure Hash Algorithm 1); SHA-2, which includes SHA-256, SHA-384, and SHA-512; or other like algorithms. Some suitable example algorithms generate a sequence of binary digits from the input data, e.g., the unique string. The hash value can be represented using the sequence of binary digits or a hexadecimal (hex) string representative of the binary digit values of the sequence of binary digits. Using hashing algorithm 118, each different unique string will correspond to a different generated hash value.

As will be discussed, the spacing pattern generated using a unique font file version is based on the generated hash values. As such, each spacing pattern may be different and, therefore, uniquely identify a potential source corresponding to the individual or device for which the hash value was generated. To so do, various information associated with the individuals or devices, such as the unique strings and the hash values, may be stored in source indexes 116.

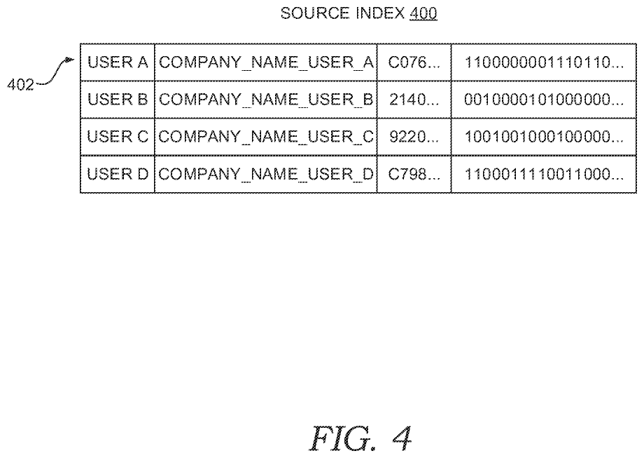

FIG. 4 provides an example source index 400. Source index 400 includes the users A-D 302-308 along with their corresponding unique strings and hash values generated with respect to FIG. 3. It will be understood that this is only an example index that may be used in some aspects of the technology for generating unique font file versions and determining the source of a document. More or less information may be included in a source index, such as source index 400. Some aspects, of the technology may not use a source index, but rather, they might regenerate the unique strings or hash values at the time of detection. However, for aspects using a source index, FIG. 4 provides a suitable example that may be used as source index 116 of FIG. 1 and may be used by various components for generating unique font files and detecting sources.

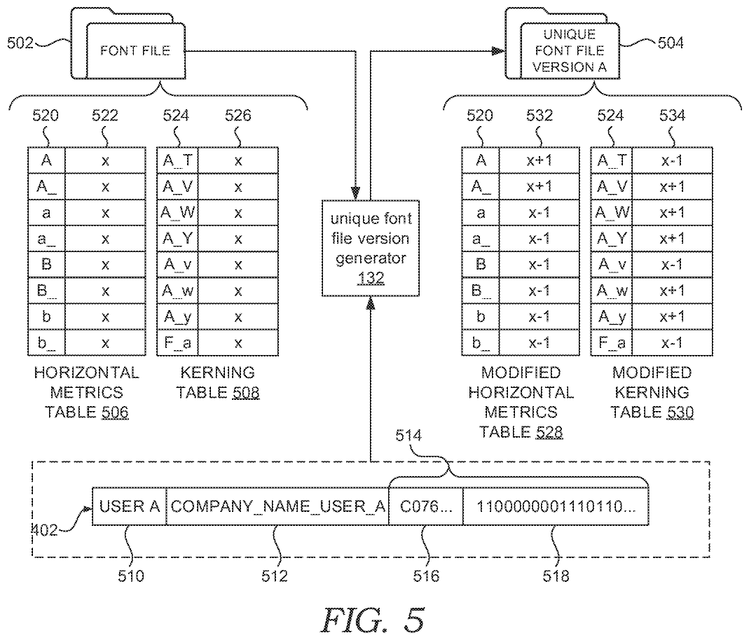

Turning now to FIG. 5, an example illustration in which a hash value generated by hash determiner 130 at FIG. 3 is used to generate unique font file version 504 from font file 502. As noted, unique font file version 504 may be used by a device to render a spacing pattern within text of a document that uniquely identifies a candidate source, which is user 510 in this particular example. FIG. 5 provides only one example in which a unique font file version is generated. However, unique font file engine 110 may generate any one or more unique font file versions for a font, such as any one or more unique font file versions from the data provided in source index 400 of FIG. 4.

In the illustrated example, unique font file version generator 132 is used to generate unique font file version 504 from font file 502 using a portion of the information from source index 400, including row A 402. Here, unique string 512 has been generated for user 510, and hash value 514 has been determined from unique string 512 using components of unique font file engine 110. In some aspects, hash value 514 may be represented as hex digest 516 or a value, such as a sequence of binary digits 518. Sequence of binary digits 518 may be used by unique font file version generator 132 when generating unique font file version 504 from font file 502.

As noted, glyphs can be rendered using data within a font file, such as font file 502. At a high level, unique font file version generator 132 can modify aspects of the data within the font file to generate a unique font file version, where glyphs rendered with the unique version comprises adjustments to a width or height in a manner that is unique to the unique font file version based on the hash value 514, such as sequence of binary digits 518.

In general, a glyph comprises a graphical representation of a character or symbol within a font. Glyphs can include letters, numbers, punctuation marks, spaces, or any other symbol used in writing or printing. Each character in a font may be represented by one or more glyphs, which define the visual appearance of the character when rendered. Glyphs may vary in appearance, style, and design, depending on the typeface and font. For example, the letter “A” in one font may have a different glyph than the letter “A” in another font, even though they represent the same character. Glyphs may be stored as vector graphics, bitmaps, or the like within font files, allowing them to be rendered by a computing device accessing the font file. Text generally includes one or more glyphs. Glyph spacing may be measured in ems (em), pixels (px), points (pt), or other like units.

A font file, such as font file 502 and font file 122 of FIG. 1, comprises a computer-readable file or other storage arrangement that contains information about a font. A device may access a font file at a local storage address or a remote storage address to generate glyphs of the corresponding font. A font file typically includes the metadata and other necessary data to represent and render glyphs according to the specific font. One example font files include TrueType Font (.ttf). Other examples include OpenType Font (.otf); PostScript Font (.pfb, .pfm); Web Open Font Format (.woff, .woff2); SVG Font (.svg); and the like.

Font files can include font tables, such as horizontal metrics table 506 and kerning table 508 of FIG. 5. In general, a font table is a data structure that includes structured information within the font file for rendering glyphs. Font files may have various types of tables, and the description and type of glyph information held within each table varies between different types of font files. Some font files include a horizontal metrics table that determines a glyph width, or how wide a particular glyph or glyph feature is when rendered. Font files may include a vertical metrics table that determines a glyph height, or the vertical distance for a particular glyph or glyph feature when rendered. Font files may include a kerning table that determines spacing between specific pairs of glyphs when the specific glyph pairs are rendered. Additional tables or combinations of tables may be included in font files.

In some font tables, glyph spacing is defined in terms of a unit of measurement, such as ems, pixels, points, and so forth. In some aspects, font tables include a specific coordinate system in which glyphs are generated according to the coordinate system. In some aspects, font tables may measure glyph spacing according to a font unit, e.g., a defined unit of distance where glyphs are generated to have a glyph spacing relative to the defined font unit. As will be further described, these measurement values may be modified in the font tables to adjust the glyph spacing when rendered.

It is noted that the term “table” is not meant to imply a particular type of data structure, and that data may be included in a tabular format or another structured format and still be within the meaning of a font table. Font table is further not meant to imply a single table, as there are various data structures that may be used. As such, information for rendering glyph width, glyph height, kerning distance, and other glyph features may be included in any one or more tables or combinations of tables. Thus for example, a horizontal metrics table generally includes any data structure that comprises the horizontal glyph information. Likewise, a kerning table is meant to include any data structure that comprises kerning distance information for specific pairs of glyphs. Moreover, a vertical metrics table is meant to include any data structure that comprises vertical glyph information, and so forth.

As illustrated in FIG. 5, font file 502 comprises horizontal metrics table 506 and kerning table 508. Each of the font tables illustrated is intended to provide an example. The illustrated font tables and other font tables, in other arrangements and data formats, may be included within font file 502. In this example, horizontal metrics table 506 provides information about horizontal glyph spacing for particular glyphs. Here, horizontal metrics table 506 comprises glyph type 520 that indicates what glyph is generated using the glyph information within horizontal metrics table 506. Each glyph of glyph type 520 in this example has a respective horizontal value 522 of “x” that indicates the width of the rendered glyphs. Likewise, kerning table 508 provides information about spacing between specific pairs of glyphs. Kerning table 508 comprises glyph type 524 that indicates what glyph is generated, which comprises glyphs for the spacing between the specific pairs of glyphs of kerning table 508. Each glyph of glyph type 524 in this example has a respective horizontal value 526 of “x” that indicates the width of the rendered glyphs between the corresponding specific pairs of glyphs. In both example tables, the glyph width has been represented as “x” for simplicity and ease of illustrating the technology. However, it will be understood that other data types and elements for rendering glyphs, including those identifying various relative glyph spacing sizes, may be present. Moreover, “x” as a representative value in this particular example is not meant to imply that every glyph width is the same, but is intended to represent the information that, at least in part, determines glyph width for the particular glyphs illustrated.

Either or both of horizontal metrics table 506 and kerning table 508, or any font tables, such as a vertical metrics font table, can be modified by unique font file version generator 132 in accordance with hash value 514 to generate unique font file version 504. In this example, each of horizontal metrics table 506 and kerning table 508 have been modified to respectively generate modified horizontal metrics table 528 and modified kerning table 530, which are included in unique font file version 504.

In an aspect, a font table is modified according to the hash value by modifying a font table value that determines glyph spacing for a glyph. In FIG. 5, the font table values are represented by “x.” For instance, a value of a digit within the hash value may be used to determine the adjustment to the font table value that, in turn, can be used to render a glyph with a glyph adjustment to the glyph spacing, such as increasing or decreasing a glyph width of the glyph or aspect thereof, or increasing or decreasing a glyph height of the glyph or aspect thereof.

In aspects, unique font file version generator 132 reads the values within the hash value and makes adjustments to font table values according to an adjustment sequence, which may include any sequence of glyphs within a font table. In FIG. 5, the adjustment sequence for modifying the font table values is [A, A_, a, a_, B, B_, b, b_. . . ] for horizontal metrics table 506 and [A_T, A_V, A_W, A_Y, A_v, A_w, A_y, F_a . . . ] for kerning table 508. Here, “_” is representative of a glyph that is rendered as a space character. Other adjustment sequences may be used when adjusting a font table. One or more font tables may be adjusted. Thus, aspects of the technology may be configured to adjust any combination of glyph height or glyph width, including the height or width of certain glyph aspects (e.g., individual features of a glyph, such as a crossbar in a capital A and H, the foot of glyph in serif type fonts, or angled legs that occur in certain letters like K and R).

In an aspect, the hash value comprises a sequence of digits. The sequence of digit values provided by the hash value may be used by unique font file version generator 132 to modify the font table, thereby adjusting the rendered glyphs, according to the sequence of digits. That is, a value in the sequence may represent a first glyph adjustment, such as an increase in a height or width. In aspects, a value may represent a second glyph adjustment, such as a decrease in a height or width. In an aspect, a value may represent no modification made to the font table. Any combination of these adjustment types, among others, may be used when modifying font table values to render a particular spacing pattern when using a unique font file version having the modified font table.

In an aspect, a hash value comprises a sequence of binary digits. For instance, hash value 514 comprises sequence of binary digits 518. Each binary digit value may correspond to a glyph adjustment to the glyph spacing. For example, a value of 0 and 1 may each be assigned an increase or decrease in a height or width of the glyph spacing, or may represent no modification made to a glyph spacing. In the illustrated example, the value “0” has been assigned to represent a decrease in the glyph width of glyph type 520 and glyph type 524, while the value “1” has been assigned to represent an increase in the glyph width of glyph type 520 and glyph type 524. As such, modified horizontal metrics table 528 comprises modified horizontal values 532 that include modified font table values “x+1” for “A,” “x+1” for “A_,” “x−1” for “a,” and so on, and modified horizontal value 534 that includes modified font table values “x−1” for “A_T,” “x+1” for “A_V,” “x+1” for “A_W,” and so on. Based on the modifications made to modified horizontal value 532 and modified horizontal value 534, each of the glyphs corresponding to “x+1” will be rendered with a glyph adjustment causing the glyph to be relatively wider than would otherwise be rendered for the same glyph using font file 502. Likewise, each of the glyphs corresponding to “x−1” will be rendered with a glyph adjustment that causes the glyph to be relatively less wide than would otherwise be rendered for the same glyph using font file 502. A similar approach may be used for vertical glyph adjustments in combination with or in lieu of the horizontal glyph adjustments. Aspects in which glyphs are rendered with both increased and decreased heights and widths have been found to be particularly beneficial because a relatively large amount of encoded information can be included within only a small area or portion of text, helping to identify document sources even when there is only a small portion of a document recovered as an artifact.

Thus, the spacing pattern within text generated using unique font file version 504 is ultimately determined from hash value 514. Since hash value 514 is unique to an individual or device, by way of unique string 512, the spacing pattern included within the text can be used to identify user 510. That is, the text encodes at least a portion of the hash value 514 as represented by the spacing pattern, which can be used to identify user 510 through techniques that will be further described.

The unique font file versions generated by unique font file version generator 132, such as unique font file version 504, may be stored as unique font file versions 124. In general, access may be provided to unique font file versions 124 for a device so that a device renders text accordingly using its respective unique font file versions. Providing access may include storing a unique font file version locally at a computing device. In this way, the device accesses the unique font file version at a local storage address and renders text accordingly. A plurality of devices may be provided local access to separate unique font file versions within unique font file versions 124 so that each device renders text with a different spacing pattern. In aspects, devices may be provided remote access to respective unique font file versions of unique font file versions 124. In doing so, each device may be given or otherwise may access a remote storage address for its respective unique font file version. As such, when the device renders text, it may do so according to the unique font file version accessed remotely. This may allow organizational flexibility when providing its individuals or devices with access to their respective unique font file versions for rendering text. For example, a device may render text from a downloaded unique font file version or may access information rendered with its corresponding unique font file version at a webserver. Other like methods for providing devices access to unique font file versions may be used in addition to or in lieu of the examples described.

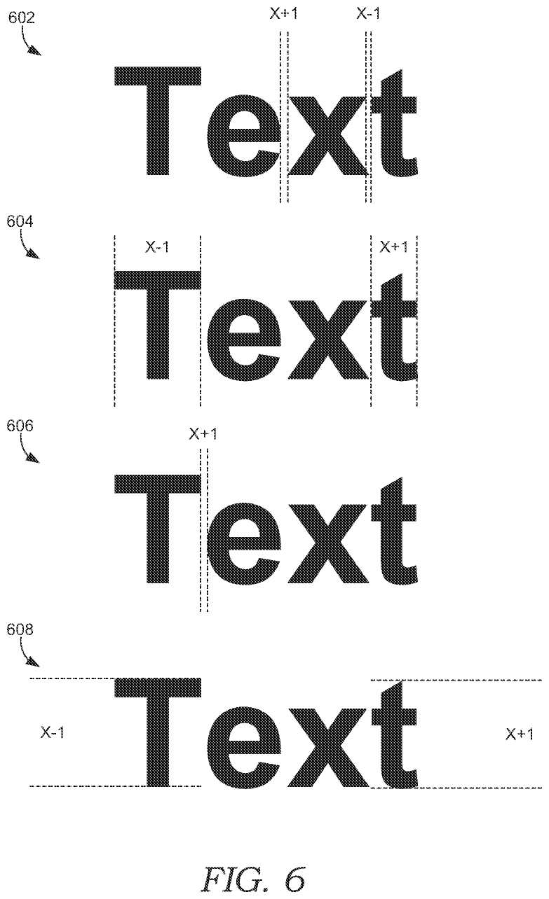

When a device, such as client device 104 accesses a unique font file version and uses it to generate text, the text comprises adjustments to the glyph spacing, thus providing a spacing pattern specific to the unique font file version. FIG. 6 illustrates some example renderings that may result from using a unique font file version to generate text. The renderings in FIG. 6 that are provided as examples are not meant to be an exhaustive illustration that includes all types of possible adjustments. A select few examples are provided to aid in describing the technology.

FIG. 6 illustrates four example renderings generated using one or more unique font file versions, including rendering A 602, rendering B 604, rendering C 606, and rendering D 608. Rendering A 602 illustrates two possible adjustments to glyph spacing. A first glyph adjustment comprises an increase in glyph width. Here, the first glyph adjustment corresponds to the space character between “e” and “x.” As indicated, the spacing generated between the “e” and “x” from the original font file could be represented as “x.” Thus, in this example, the unique font file version of the font file generates a first glyph adjustment that is an increase in the horizontal width of the space character following the character “e” or preceding the character “x,” represented as “x+1,” relative to the original font file. In rendering A 602, the unique font file version used to generate the text has also rendered a second glyph adjustment that corresponds to the space character between “x” and “t.” The spacing generated between the “x” and “t” from the original font file is also represented here as “x.” Thus, in this example, the unique font file version generates a second glyph adjustment that is a decrease in the horizontal width of the space character following the character “x” or preceding the character “t,” represented as “x−1,” relative to the original font file.

Rendering B 604 illustrates another two possible adjustments to glyph spacing generated by a unique font file version. In this example, a first glyph adjustment comprises a decrease in horizontal glyph width of the upper case character “T” relative to the same character rendered from the original font file. The first glyph adjustment is illustrated as “x−1.” Further, rendering B 604 also illustrates a second glyph adjustment that comprises an increase in horizontal glyph width of the lowercase character “t” relative to the same character rendered from the original font file. The second glyph adjustment is illustrated as “x+1.”

Rendering C 606 illustrates another possible adjustment to glyph spacing generated by a unique font file version. This example includes a glyph adjustment of a space character between a specific pair of glyphs comprising the adjacent characters “T” and “e.” In some font files, the distance between specific pairs of glyphs may be different than when the glyphs are used in other combinations. This is often referred to as kerning and may be done to make the text more aesthetic and readable based on certain character shapes. For instance, with reference to rendering C 606, the original font file may specify that the glyph between “T” and “e” may have a more narrow width than when “T” and “e” are used with other combinations of glyphs. As such, aspects of the technology may also make adjustments to between specific pairs of glyphs in some font files. Illustrated here, the glyph for the space character between “T” and “e” has been adjusted to increase the horizontal glyph width relative to the glyph otherwise generated by the original font file. Thus, in aspects, glyphs appearing between specific pairs of characters may be adjusted differently than when the glyph appears independently or in combinations with other glyphs.

Rendering D 608 illustrates another two possible adjustments to glyph spacing generated by a unique font file version. Rendering D 608 includes vertical glyph adjustments. In this example, a first glyph adjustment comprises a decrease in vertical glyph height of the upper case character “T” relative to the same character rendered from the original font file. The first glyph adjustment is illustrated as “x−1.” Further, rendering D 608 also illustrates a second glyph adjustment that comprises an increase in vertical glyph height of the lower case character “t” relative to the same character rendered from the original font file. The second glyph adjustment is illustrated as “x+1.”

The foregoing examples provide text rendered by one or more unique font file versions, and thus encode unique spacing patterns within the text. Often, the spacing pattern, including the differences between spacing patterns generated by different unique font file versions, are challenging to detect through general visual observation. However, as will be described, certain techniques can be applied to identify the spacing pattern, and from it determine the source of a document from an artifact.

Turning back to FIG. 1, decoder 112 may be applied to determine the source of a document from a recovered artifact. For example, this could be done in the event there is a leak and an artifact is recovered.

In general, artifacts are recovered documents or derivations thereof. An artifact may comprise an entire document or derivation of the document. In aspects, an artifact is a portion of the document or a derivation thereof. Artifacts may include physical or digital objects. For instance, an artifact may be a whole document of the same file type. For example, this may occur if a document is attached to an email or included in the body of an email that is then forwarded to another recipient. An artifact may be a portion of a document that is the same file type. As an example, if a portion of a PDF document is provided to someone other than the initial recipient as a pdf, the portion provided is an artifact of the document. In another example, the artifact may be a whole or partial replication of a document that is in a different format. For instance, a photo, snip, cut-and-paste, retype, translation, or other method of duplicating text within the document can be used to derive an artifact. Artifacts may be in the form of computer-readable file formats, photos (including various angles), printed documents, copied-and-pasted content, email attachments, email body messages, and other like objects. Artifacts may include compound derivatives, such as those artifacts having multiple or combinations of derivations from the document. For instance, this can include a photo of a printed version of a document, or a document that has been converted through various file formats. Another example may include a reprint of text from a document, such as a forwarded email message that is then printed. It will be appreciated that there are a robust number of distribution methods that can generate an artifact.

To determine the source of a document from a recovered artifact, the example decoder 112 illustrated in FIG. 1 may employ combinations of font type determiner 134, text classification engine 136, data sequence determiner 138, hash value identifier 140, and source determiner 142.

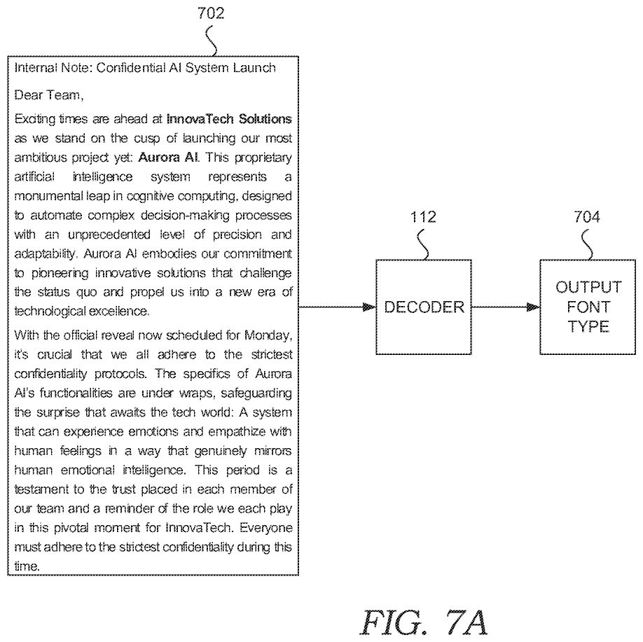

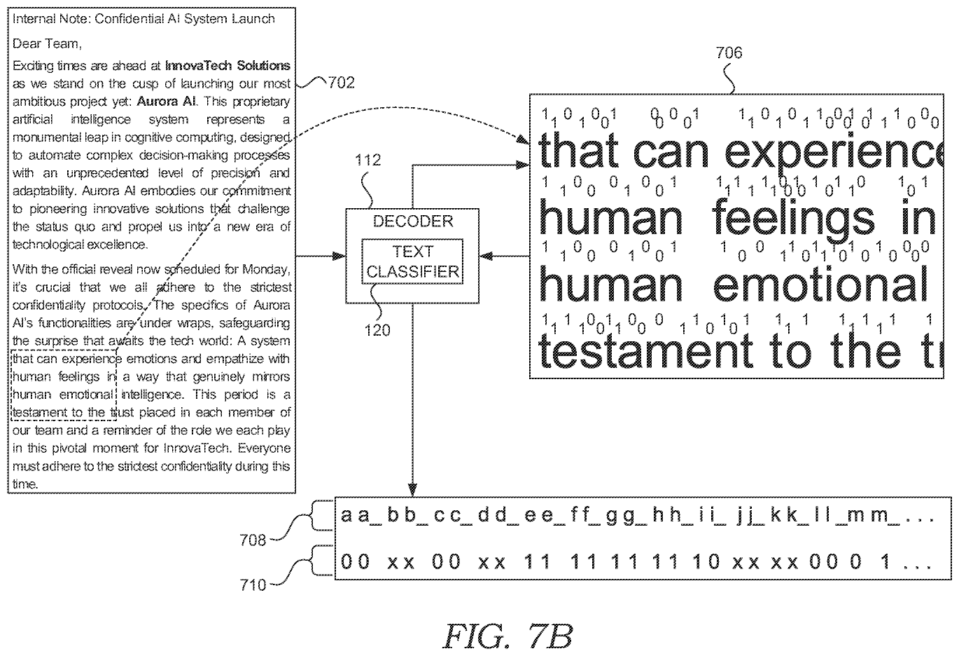

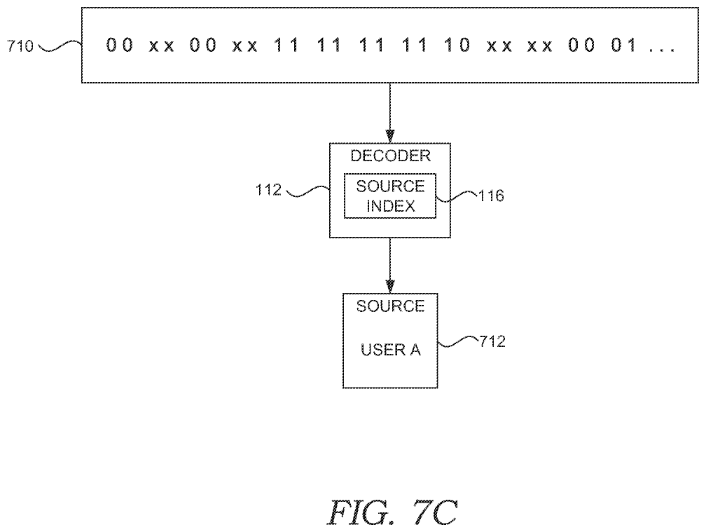

One example method determines a font type of a font within an artifact and then classifies glyphs in the artifact to determine glyph spacing in the artifact relative to a font file for the font type. The relative glyph spacing for the various glyphs can be used to generate a data sequence. The data sequence can be compared to the hash values corresponding to candidate sources, such as hash values stored in source index 116. Based on the comparison, the source of the document corresponding to the artifact is determined. FIG. 7A-FIG. 7C illustrate an example in which decoder 112 is used to determine the source of a document corresponding to artifact 702. Reference will be generally made to these figures in addition to FIG. 1.

In an example process, performed by decoder 112, when an artifact is recovered and the artifact includes text, font type determiner 134 can be used to identify the font type of the text. As illustrated in FIG. 7A, decoder 112 outputs font type 704, which may include one or more font types determined from artifact 702. There are various different categories of font types, such as serif, sans serif, script, decorative, and the like type fonts. Each of these may include various individual font types. Many of the font types have a corresponding font file that is used to generate glyphs in accordance with the style of the particular font. Since some font types have different glyph spacings, some aspects of the technology initially identify the font type of the artifact before classifying the text of the artifact. Classification of the font type can also help determine the font file for which to compare and classify any glyph adjustments in the artifact.

Font type determiner 134 may apply an OCR (optical character recognition) system to determine a font type of text within an artifact. In general, various OCR systems may be used, including those trained in traditional character recognition. OCR systems may further include machine learning models, such as CNNs (convolutional neural networks), that are trained using different labeled font types. By applying these models on the text within the artifact, font type determiner 134 may identify one or more font types within the artifact. In some aspects, font type determiner 134 identifies which text is included within the identified one or more font types. That is, font type determiner 134 may identify a first portion of text as corresponding to a first font type. In aspects, where there are a plurality of font types, font type determiner 134 may identify at least a second portion of text as corresponding to a second font type, and so on.

As part of identifying a spacing pattern within the artifact, text classification engine 136 may be employed to classify glyph spacing within the text of the artifact. To do so, text classification engine 136 may employ text classifier 120. In general, text classifier 120 may be trained to classify glyph spacing, including glyph width or height, or an aspect of a glyph. In aspects, text classifier 120 identifies and classifies glyphs, including spaces between glyphs, within the text. In aspects, text classifier 120 may be trained to classify glyphs according to their size in an artifact relative to the glyph size when generated by an original font file. In aspects, the glyph spacing of the text within the artifact is classified relative to the glyph spacing generated by text of an original font file for a font matching the font of the artifact as determined by font type determiner 134. In aspects, text classifier 120 may be trained to classify the relative glyph size to determine whether the glyph spacing is relatively larger or smaller, or whether there is no relative adjustment in glyph size, or any combination of one or more of these classifications.

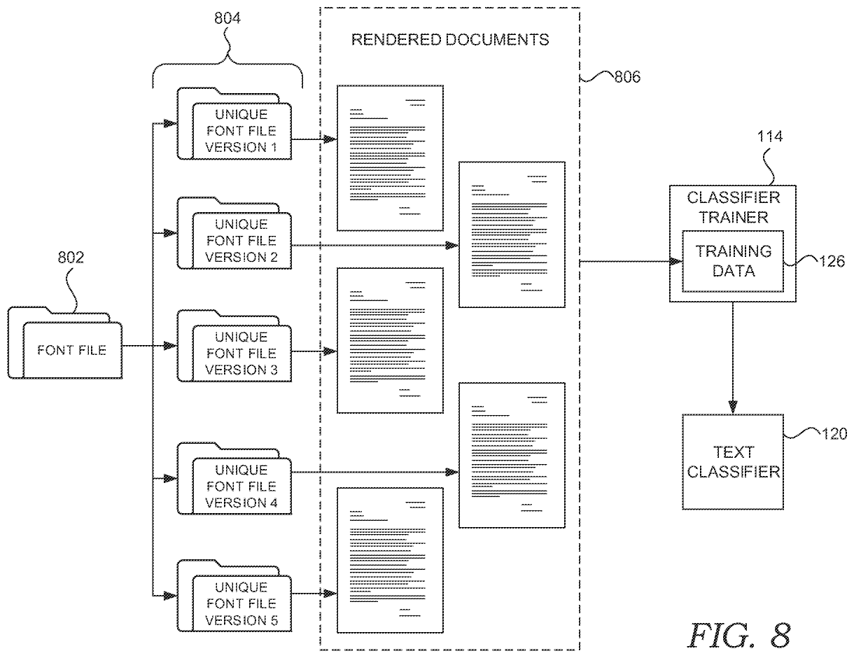

Text classifier 120 may include various types of machine learning algorithms, including combinations of algorithms and machine learning processes. Many deep learning algorithms are particularly suitable to identifying glyphs and classifying glyph spacing within text. Suitable example machine learning algorithms may include types of CNNs. Some algorithms might include SMVs (support vector machines), autoencoders, vision transformers, GANs (generative adversarial networks), or the like. Such algorithms may be trained using supervised, semi-supervised, or unsupervised learning techniques based on the type of algorithm(s) being used. An example training using training data 126 will be further described with reference to FIG. 8 and classifier trainer 114.

With reference now to FIG. 7B, an example classification that can be performed using text classification engine 136 of decoder 112 employing text classifier 120 is provided. In aspects, the example continues from the example provided in FIG. 7A. In some aspects, based on the algorithm and training of text classifier 120, decoder 112 may employ text classifier 120 without regard to the particular font type. In this example, classified text 706 is a portion of the text from artifact 702 and is generally show to illustrate how text classifier 120 might classify various glyphs within the text. It will be realized that other classification schemes may be used, and illustration provides a visual example that is used to help describe the technology.

According to the example shown, text classifier 120 has classified various glyphs, such as the one or more glyphs forming characters of the text illustrated in classified text 706. Here, glyphs corresponding to the characters have been classified based on whether the relative glyphs spacing is greater or less than it would otherwise be if rendered using an original font file corresponding to the unique font file version that was used to generate artifact 702. As shown, text classifier 120 has assigned a “1” to the glyph spacing of the glyphs forming the characters that are relatively greater (e.g., relatively wider or taller), while text classifier 120 has assigned a “0” to the glyph spacing of the glyphs forming the characters that are relatively less (e.g., relatively narrower or shorter). In aspects, such as the one shown, text classifier 120 is trained to classify glyph spacing for individual characters and the spacing between the characters. In some aspects, text classifier 120 could be configured to omit a classification for spaces between words, such as the space between “that” and “can” for the first two words of classified text 706. This option may be helpful in avoiding errors in glyph space classification stemming from changes to certain text alignment techniques, such as a justified text like that of artifact 702.

Referring generally back to text classifier 120, as previously noted, text classifier 120 may be trained to classify glyph spacing within text. Referring to FIG. 1, classifier trainer 114 may be used to train text classifier 120 for text classification. Many of the models, including various CNNs, described above are trained at least in part using a supervised learning method. This may be done using a labeled dataset, generally described and illustrated as training data 126. Classifier trainer 114 may employ training data generator 144 to generate training data 126, and training engine 146 may be employed to train a model using training data 126.

With brief reference to FIG. 8, an illustrative training example is provided in which training data for training data 126 is generated using training data generator 144. To do so, a font file such as font file 802 is provided. Using methods previously described with respect to unique font file engine 110, a plurality of unique font file versions may be generated from the font file. As an example, a string may be generated and from it a hash value determined. The hash value is used to modify an original font file to generate a unique font file version. A plurality of strings, each unique from one another, may be generated to provide various unique font file versions.

In the illustrated example, unique font file versions 804 are generated from font file 802. Training data generator 144 may render a document from each of the unique font file versions, such as rendered documents 806. Since the modifications to the font tables within the unique font file versions are known, the respective glyph adjustments within the text of the rendered documents can be labeled, thus identifying for training engine 146 which glyphs in the rendered documents correspond to what type of glyph adjustment. The rendered documents having labels corresponding to the type of glyph adjustment are provided as training data 126. Training engine 146 can employ a training technique for the particular model using training data 126 to train the model for use as text classifier 120 in identifying and classifying adjustments to glyph spacing within a document.

In some aspects, classifier trainer 114 may train a text classifier based on a font type. That is, in such a system, each different font file for a plurality of font types may be used to train a respective classifier, thus providing a plurality of classifiers from which to select based on a determined font type.

In some aspects, one or more distortions may be applied to rendered documents, such as rendered documents 806. The distorted rendered document may be included as part of training data 126. Bending and blurring of the rendered document are two such examples. Doing so may help the resulting trained text classifier identify glyphs and classify their respective relative glyph spacing in artifacts having distorted text.

In some aspects, training data 126 may comprise rendered documents having a plurality of different document types, such as text files, slide decks, and so forth. This may help the resulting trained text classifier 120 be robust to different variations of a document that may occur when recovering an artifact of that document.

In some aspects, various text styles may be applied to the text within a rendered document, and the documents having the text styles may be stored as part of training data 126. For example, the color, text size, or other style may be modified within the text of a rendered document. Training on such a document may help to improve the robustness of text classifier 120 when classifying text in altered documents or where the text was rendered in a document having various stylistic effects.

These are some example modifications to rendered documents that may be included as part of training data 126. Other modification and document rendering methods may be used to improve the robustness of text classifier 120 in identifying glyphs and classifying adjustments to glyph spacing. Moreover, other training methods and training data generation method may be employed in addition to or in lieu of the examples described herein.

Now, turning back to FIG. 1, having classified the text using text classification engine 136, data sequence determiner 138 may be employed to determine a data sequence from the classified text. As will be described, the data sequence can be used to identify the hash value that corresponds to the source of artifact 702. In general, data sequence determiner 138 orders the classified text according to an adjustment sequence. As noted, the adjustment sequence may include any sequence of glyphs within a font table, and may be used to modify the font table. The adjustment sequence for ordering the text may be the same as the adjustment sequence used to modify the font file when generating the unique font file versions. In such cases, the classified values ordered according to the adjustment sequence may allow comparison of the values from the classified text to the hash values of potential sources.

In the example shown in FIG. 7B, a portion of an adjustment sequence is illustrated by adjustment sequence 708. This corresponds to the adjustment sequence that was used to generate the unique font file version from which a document corresponding to artifact 702 was rendered. Accordingly, decoder 112 employing data sequence determiner 138 can determine a data sequence from classified text 706 in accordance with the adjustment sequence. That is, data sequence determiner 138 orders the classifications according to the adjustment sequence. For example, the first and second glyphs in adjustment sequence 708 are used to render the characters “a” and the space following “a” (represented as “a_”). Data sequence determiner 138 orders the classification for “a” within classified text 706 as the first value within data sequence 710. Likewise, data sequence determiner 138 orders the classification for “a_” as the second value within data sequence 710. In this example, the glyph spacing for both “a” and “a_” was classified as relatively less and given a value of “0” by text classification engine 136. Data sequence determiner 138 continues in this fashion, ordering all or a portion of classified text.

As shown in the example, it's possible that an artifact does not include all possible glyph adjustments that could be rendered using a unique font file version. Thus, the generated data sequence may comprise all or a portion of a hash value generated by unique font file engine 110 when generating unique font file versions. Moreover, there may be some cases where text classifier 120 outputs an error in the classification, and as such, the generated data sequence may not exactly match a previously generated hash value. As will be described, a generated data sequence 710 in whole or in part, or including some degree of error, may still be used to identify the source.

To identify a possible source of an artifact, decoder 112 may hash value identifier 140 and source determiner 142, shown in FIG. 1. In general, hash value identifier 140 identifies a hash value using the data sequence. From the identified hash value, source determiner 142 can determine the source of the artifact.

To do so, hash value identifier 140 may compare a data sequence determined from an artifact's classified text to hash values generated using unique font file engine 110. In some cases, this may be done by accessing the hash values stored in source index 116. As noted, there may be aspects where the hash values are regenerated from unique strings for the comparison.

Various comparison methods may be used, including matching algorithms that determine the statistical significance of a match between the data sequence and the hash value. One suitable example uses Pearson correlation. In doing so, the statistical likelihood of the data sequence matching a hash value can be determined relative to the data sequence matching another hash value. A threshold significance can be used by hash value identifier 140 when identifying a hash value from a data sequence using this method.

Using the identified hash value, source determiner 142 may determine the source of an artifact. As noted, each hash value is generated from a unique string that uniquely identifies an individual or device. In aspects, source determiner 142 references source index 116 and identifies the unique string, and from it, the source corresponding to the identified hash value.

Continuing with the example in FIG. 7C, the data sequence 710 determined in FIG. 7B is used by decoder 112 to identify source 712 using source index 116. Here, a source is representative of an individual or device corresponding to a unique font file version that was used to render the document corresponding to artifact 702. The output of decoder 112 providing the source can be a useful starting point when trying to determine the source of a leaked document from a recovered artifact, such as artifact 702.

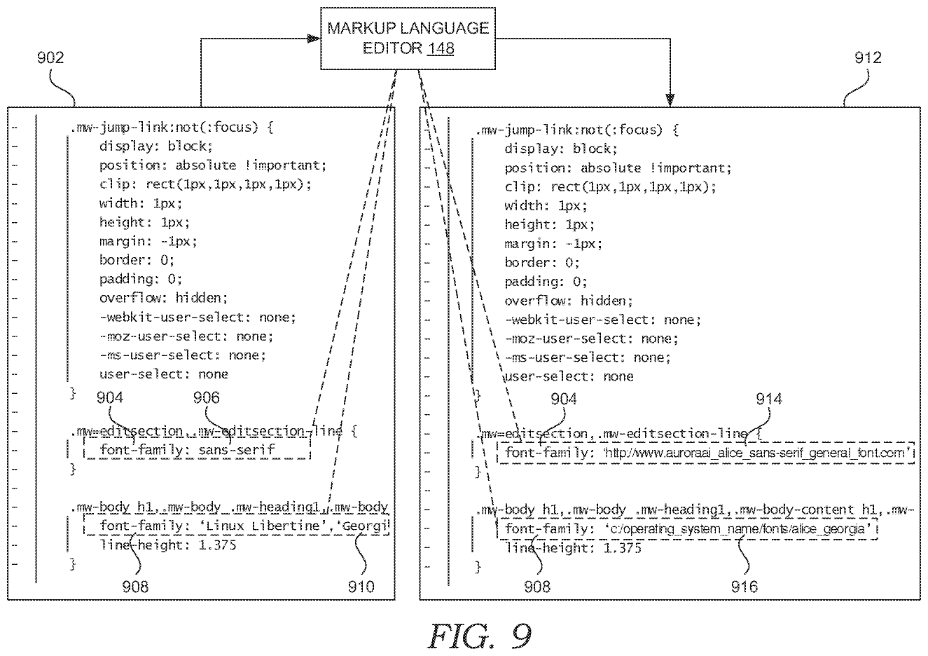

Referring now to FIG. 1 and to FIG. 9, a particular example in which client device 104 can render text using a unique font file version is provided. As noted, the unique font file version may correspond to client device 104 or an individual using client device 104. As noted, client device 104 may render text using a unique font file version by accessing the unique font file version via a local storage device or remotely.

In some cases, text and other objects may be rendered by client device 104 from a markup language. In general, a markup language comprises a text-encoding system that specifies the structure and formatting of a document and potentially the relationship between its parts. For instance, a markup language may comprise a set of rules governing what markup information is included in a document and how it is combined within the document when rendered. Markup language, as described herein, may include systems such as HTML (HyperText Markup Language), XML (eXtensible Markup Language), LaTeX, Markdown, SVG, RTF (Rich Text Format), SQL (Structured Query Language), JSON (JavaScript Object Notation), and the like. Various software programs and systems may read markup language and render text. Some examples includes web browsers, text editors and content managers, document processing software services, various database management and information retrieval systems, web servers and application servers, digital publishing platforms, ebook readers, and the like.

In an aspect, markup language can be edited by markup language editor 148 so that the text rendered from the markup language is rendered with the spacing pattern generated by a unique font file version. Aspects of these methods may be particularly beneficial because web pages' and other documents' access using client device 104 may be rendered with the identifying spacing pattern. Thus, one individual or device accessing a website, intranet site, or other document derived from markup language may appear different than when the same document is accessed by another individual or device that has been provided a different unique font file version. This can provide a way for documents stored in sharable memory to appear with different identifying spacing patterns based on the particular individual or device that accesses the document, thus helping to prevent leaks and identify the source of a leak of shared documents if one does occur.

In one such example, markup language editor 148 can be employed to edit markup language so that documents rendered from the markup language include spacing patterns specific to the user accessing the document. To do so, the example markup language editor 148 uses markup language identifier 150 and markup language replacer 152.

For instance, prior to or contemporaneously with client device 104 accessing a document rendered from a markup language, markup language editor 148 may identify that the document is being generated from a markup language. For instance, this may be done based on the format of the markup language itself, such as a web page being rendered from HTML. The markup language used to render the document may specify one or more font types for the rendered text. In the example provided by FIG. 9, markup language 902 includes font type 906 and font type 910. In aspects, markup language identifier 150 identifies the font type based on an indexed name of font types. In some aspects, markup language identifier 150 may identify the font types based on a listed property in the markup language. In markup language 902, font property 904 and font property 908 are provided and could be used to identify font type 906 and font type 910, respectively. With edits to the markup language 902, markup language 902 may be used to render a document from one or more original font files for font type 906 and font type 910.

However, markup language editor 148 may use markup language replacer 152 to edit markup language 902 to reference an address for one or more unique font file versions for the corresponding font types. In aspects, markup language replacer 152 replaces the font types, such as font type 906 and font type 910, with addresses of the one or more unique font file versions. The addresses may include a local address for accessing a unique font file version or a remote address, such as a URL (uniform resource locator), for accessing a unique font file version. In the example illustrated, markup language editor 148 (employing markup language replacer 152) has replaced font type 906 with remote address 914 and replaced font type 910 with local address 916. As such, client device 104, or an application thereof, may render a document using modified markup language 912 that has spacing patterns generated by the unique font file versions accessed via the addresses.

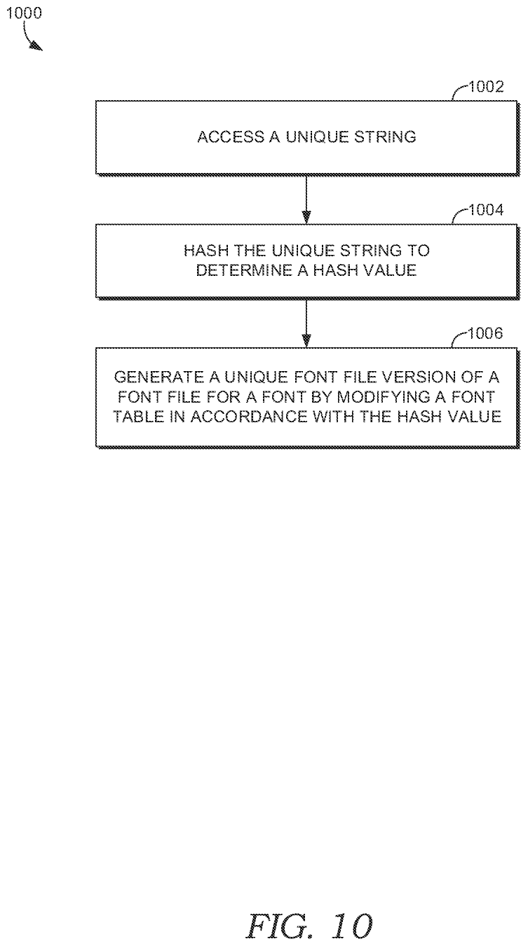

With reference now to FIGS. 10-14, block diagrams are provided respectively illustrating methods 1000-1400 that relate to aspects of document source detection using unique font file versions. Each block of the methods may comprise a computing process performed using any combination of hardware, firmware, or software. For instance, the methods can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. The methods may be implemented in whole or in part by components of operating environment 100.

Accordingly, method 1000 provides an example process for generating a unique font file version. Aspects of method 1000 may be performed using unique font file engine 110.

In block 1002, a unique string is accessed. This may be done using unique string generator 128. In block 1004, the unique string is hashed to determine a hash value. Hash determiner 130 may be employed to hash the unique string and generate the hash value. In some cases, the hash value comprises a sequence of binary digits.

In block 1006, a unique font file version of a font file is generated by modifying a font table in accordance with the hash value. The unique font file version may be generated using unique font file version generator 132. The font table may be modified to generate the unique font file version such that text rendered from the unique font file version comprises a spacing pattern for the font that is specific to the unique font file version. For instance, the spacing pattern within the text rendered from the unique font file version comprises glyph adjustments to one or more of a glyph width or glyph height. The spacing pattern of adjustments may be determined from the hash value used to modify the font table. Access to the unique font file version may be provided such that text rendered using the unique font file version encodes at least a portion of the hash value in a spacing pattern. Access to the unique font file version may be provided to a specific individual or device corresponding to the particular unique font file version and hash value from which it was generated. Access may be provided from a local storage using a local storage address or a remote storage using a remote storage address.

When modifying the font table from a hash value comprising binary digits, at least one binary digit value may correspond to a glyph adjustment. The glyph adjustment may include one of an adjustment to glyph width or glyph height, including glyphs rendered between specific pairs of glyphs. In another aspect, a first binary digit value corresponds to a first glyph adjustment for an increase in glyph spacing, such as an increase in glyph width or glyph height, including glyphs rendered between specific pairs of glyphs, and aspects thereof. Further, a second binary digit value corresponds to a second glyph adjustment for a decrease in glyph spacing, such as a decrease in glyph width or glyph height, including glyphs rendered between specific pairs of glyphs, and aspects thereof. The font table can be modified by adjusting font table values according to the sequence of binary digits so that glyphs are rendered with the corresponding glyph adjustment.

In aspects, the font table being modified may include at least one of a horizontal metrics table that determines a glyph width, and a kerning table that determines spacing between specific pairs of glyphs. For instance, the kerning table may determine the width of the space characters between specific pairs of glyphs. In addition or in lieu of modifying at least the horizontal metrics table or the kerning table, a vertical metrics table may be modified that determines glyph height.

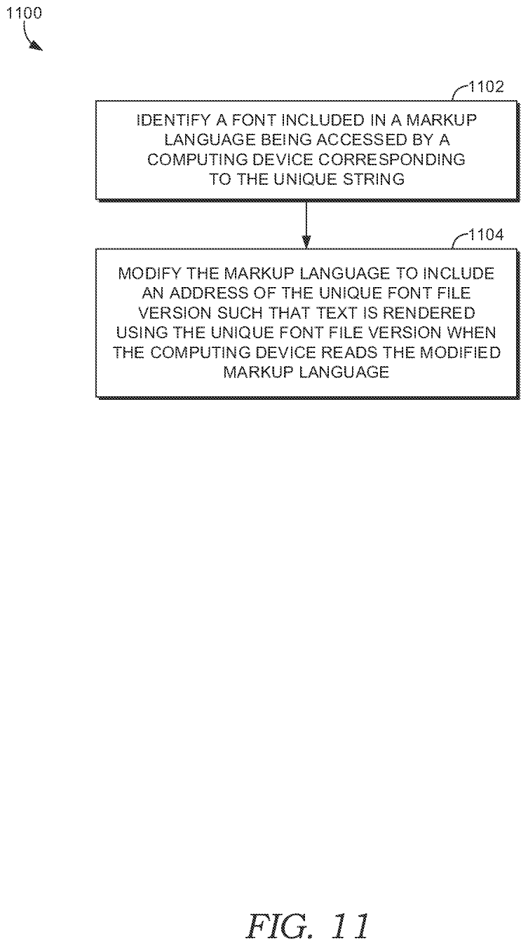

Referring to FIG. 11, an example method 1100 for modifying a markup language for rendering text according to a unique font file version is provided. Markup language editor 148 may be used to edit a markup language so that a rendered document includes a spacing pattern generated from the unique font file version.

In block 1102, a font included in a markup language being accessed by a computing device is identified. This may be done using markup language identifier 150. The computing device accessing the markup language may correspond to a unique string. That is, a unique string may have been generated for an individual using the computing device to access the markup language or may have been generated specific to the computing device itself. From the unique string a hash value has been generated and used to generate a unique font file version specific to the individual or computing device.

In block 1104, the markup language may be modified to include an address of the unique font file version such that text is rendered using the unique font file version when the computing device reads the modified markup language. This may be done using markup language replacer 152. The address may include a local address or a remote address for accessing the unique font file version. As such, the text rendered by the computing device from the modified markup language includes a spacing pattern generated from the unique font file version.

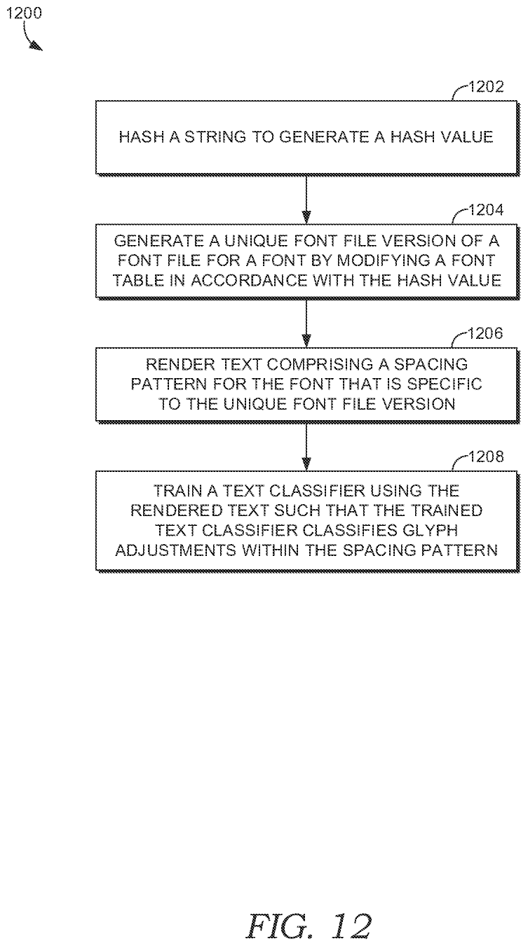

Turning to FIG. 12, an example method 1200 for training a classifier to identify glyphs and classify glyph adjustments is provided.

In block 1202, a string is hashed to generate a hash value. In block 1204, a unique font file version of a font file (e.g., an original font file) for a font is generated by modifying a font table in accordance with the hash value. The unique font file version may be generated using unique font file engine 110. In aspects, the hash value comprises a sequence of binary digits, where at least one or both of the binary digit values correspond to a glyph adjustment, including one or more of an increase in glyph width or height and a decrease in glyph width or height. When generating the unique font file version, one or more of a horizontal metrics table, vertical metrics table, or kerning table may be modified.

In block 1206, text comprising a spacing pattern for the font that is specific to the unique font file version is rendered. In some cases, the text may be to indicate glyph adjustments within the spacing pattern of the text. This may be done for models using a supervised or semi-supervised training method.

In block 1208, a text classifier using the rendered text is trained such that the trained text classifier classifies glyph adjustments (e.g., glyph width and glyph height) within the spacing pattern of the rendered text. The text classifier may be trained using classifier trainer 114.

In aspects, a plurality of unique strings is generated at block 1202 for generation of a plurality of unique font file versions at block 1204. The plurality of unique font file version may be used to generate a plurality of documents, each having text that includes a different spacing pattern, on which to train the text classifier.

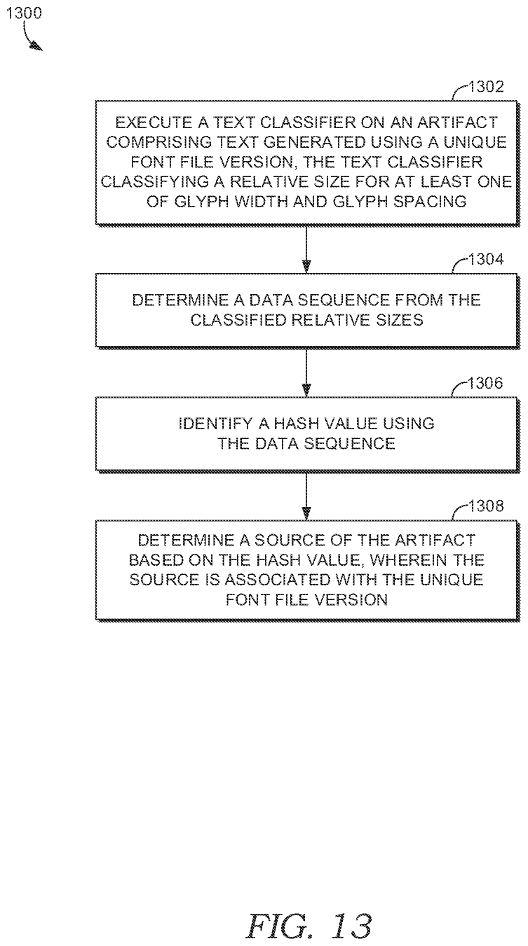

Now with reference to FIG. 13, an example method 1300 for determining the source of an artifact is provided. This may be performed using decoder 112. In block 1302, a text classifier is executed on an artifact comprising text generated using a unique font file version. The text classifier may classify a relative size of glyph spacing, such as one or more of an increase or decrease in glyph width or glyph height, including between specific pairs of glyphs, or aspects of the glyphs. This may be done using text classification engine 136. In an aspect, the text classifier assigns a binary digit value to glyphs based on a classified relative size of the glyph within the text. The binary value may represent one of an increase, decrease, or no adjustment in glyph spacing. A second binary digit value may represent one of an increase, decrease, or no adjustment in glyph spacing.

In block 1304, a data sequence is determined from the classified relative sizes. This may be done using data sequence determiner 138. For instance, the data sequence may comprise an ordered set of values corresponding to the classification at block 1302, where the order of the ordered set of values is determined from an adjustment sequence.

In block 1306, a hash value is identified using the data sequence. For instance, the hash value can be identified from among a plurality of hash values that are each associated with a different unique font file version of a font file. Pearson correlation is an example method of statistical comparison between the data sequence and generated hash values that can be used to identify one of the hash values corresponds to the data sequence determined at block 1304 with a statistical significance. This may be done using hash value identifier 140.

In block 1308, a source of the artifact is determined based on the hash value, wherein the source is associated with the unique font file version. This may be done by source determiner 142. For instance, the identified hash value may be mapped back to an individual or device using a source index.

In an aspect, the font type is determined from the artifact. This may be done using font type determiner 134. The classifier used at block 1302 may be selected based on the font type.

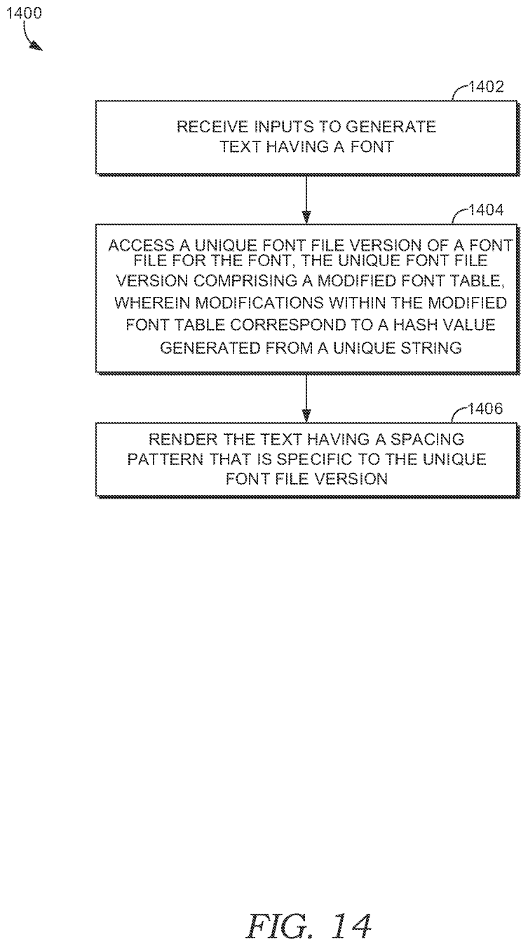

Referring now to FIG. 14, an example method 1400 for rendering text using a unique font file version is provided. In block 1402, inputs to generate text having a font are received. For instance, these may be received at a computing device. The text may be rendered in a document, and various computer programs or applications may be used to render the text.

In block 1404, a unique font file version of a font file is accessed. The font file may be accessed through a local address or a remote address. The unique font file version accessed may comprise a modified font table. The modification to the font table may correspond to a hash value generated from a unique string. For instance, the font file may have been generated using unique font file engine 110. The modification to the font table may include modification to any combination of a horizontal metrics table, a vertical metrics table, a kerning table, or other font table.

In block 1406, the text is rendered. The rendered text has a spacing pattern that is specific to the unique font file version. For instance, the spacing pattern may include adjustments to glyphs within the text that correspond to the hash value used to modify the font table. That is, the spacing pattern encodes at least a portion of the hash value. The spacing pattern may include glyph adjustments to at least one of a glyph height and glyph width, where differences in the glyph adjustments correspond to the encoded hash value.

In aspects, the hash value comprises a sequence of binary digits. A first binary value may correspond to one of a relative adjustment (e.g., increase or decrease) to the glyph height, glyph width, or no adjustment. A second binary digit value may correspond to one of a relative adjustment (e.g., increase or decrease) to the glyph height, glyph width, or no adjustment. In this way, the hash value having the sequence of binary digits may be encoded in the glyph adjustments of the glyph spacing within the rendered text generated by the unique font file version.

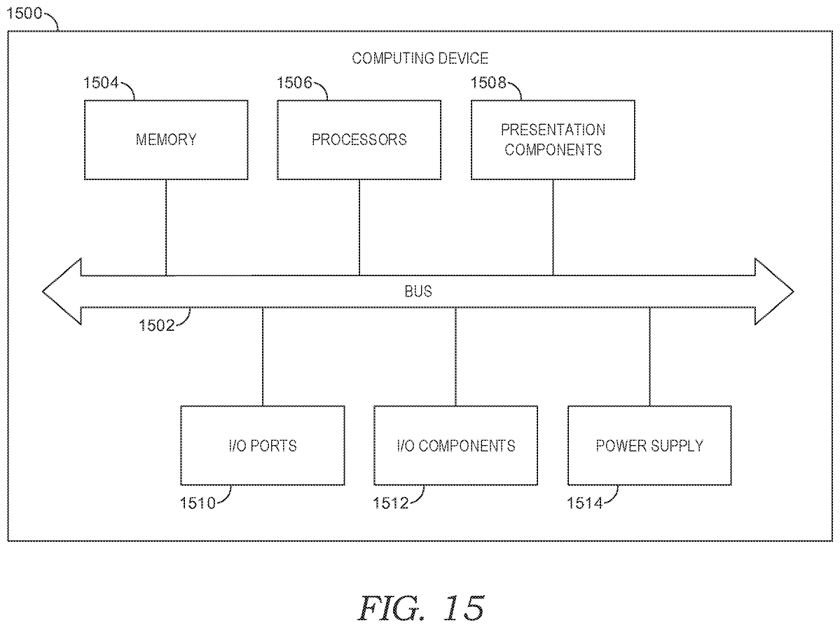

Having described an overview of some embodiments of the present technology, an example computing environment in which embodiments of the present technology may be implemented is described below in order to provide a general context for various aspects of the present technology. Referring now to FIG. 15 in particular, an example operating environment for implementing embodiments of the present technology is shown and designated generally as computing device 1500. Computing device 1500 is but one example of a suitable computing environment and is not intended to suggest any limitation as to the scope of use or functionality of the technology. Computing device 1500 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 15, computing device 1500 includes bus 1502, which directly or indirectly couples the following devices: memory 1504, one or more processors 1506, one or more presentation components 1508, input/output (I/O) ports 1510, input/output components 1512, and illustrative power supply 1514. Bus 1502 represents what may be one or more buses (such as an address bus, data bus, or combination thereof). Although the various blocks of FIG. 15 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 15 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 15 and with reference to “computing device.”

Computing device 1500 typically includes a variety of computer-readable media. Computer-readable media can be any available media that can be accessed by computing device 1500 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1500. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1504 includes computer storage media in the form of volatile or non-volatile memory. The memory may be removable, non-removable, or a combination thereof. Example hardware devices include solid-state memory, hard drives, optical-disc drives, etc. Computing device 1500 includes one or more processors that read data from various entities, such as memory 1504 or I/O components 1512. Presentation component(s) 1508 presents data indications to a user or other device. Example presentation components include a display device, speaker, printing component, vibrating component, etc.

I/O ports 1510 allow computing device 1500 to be logically coupled to other devices, including I/O components 1512, some of which may be built-in. Illustrative components include a microphone, joystick, game pad, satellite dish, scanner, printer, wireless device, etc. The I/O components 1512 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1500. Computing device 1500 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1500 may be equipped with accelerometers or gyroscopes that enable detection of motion. The output of the accelerometers or gyroscopes may be provided to the display of computing device 1500 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

With reference back to FIG. 1, an example operating environment 100 in which aspects of the technology may be employed is provided. Among other components or engines not shown, operating environment 100 comprises server 102, client device 104, and database 106, which are communicating via network 108.

Generally, server 102 is a computing device that implements functional aspects of operating environment 100, such as one or more functions of unique font file engine 110, decoder 112, classifier trainer 114, and markup language editor 148 for document source detection. One suitable example of a computing device that can be employed as server 102 is described as computing device 1500 with respect to FIG. 15.

Client device 104 is generally a computing device, such as computing device 1500 of FIG. 15. Client device 104 may perform various functions, including rendering text having spacing patterns generated from a unique font file version. In aspects, client device 104 may perform functions described with respect to unique font file engine 110, decoder 112, classifier trainer 114, and markup language editor 148 as part of a document source detection.

As with other components of FIG. 1, server 102 and client device 104 are each intended to represent one or more devices. In implementations, computing device 104 is a client-side or front-end device, and server 102 represents a back-end or server-side device. It will be understood that some implementations of the technology will comprise either a client-side or front-end computing device, a back-end or server-side computing device, or both, executing any combination of functions for document source detection. FIG. 1 is simply one example illustration of a computing environment in which the technology may be employed, although it will be recognized that other arrangements of devices and functions may be used with the technology as well. All are intended to be within the scope of the present disclosure, as will be further noted.

Database 106 generally stores information, including data, computer instructions (e.g., software program instructions, routines, or services), or models used in embodiments of the described technologies. Although depicted as a single database component, database 106 may be embodied as one or more databases or may be in the cloud.

Network 108 may include one or more networks (e.g., public network or virtual private network [VPN]), as shown with network 108. Network 108 may include, without limitation, one or more local area networks (LANs), wide area networks (WANs), or any other communication network or method.

With continued reference to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to unique font file engine 110, decoder 112, classifier trainer 114, and markup language editor 148, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of unique font file engine 110, decoder 112, classifier trainer 114, and markup language editor 148, among other functions, may be performed by server 102, client device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

The term “rendering” comprises a digital rendering, such as when a computing device displays an object at a display device as an output component. The term is further intended to comprise a physical rending, such as when a computing device prints an object using a printer as an output component.

The term “document” can be broadly described as any physical or digital medium that can record, convey, store, or display information or data in any form, including but not limited to text, images, symbols, graphs, charts, audiovisual elements, and the like. This comprises a wide range of formats such as printed paper, manuscripts, electronic files, digital canvases, web pages, images, drawings, and the like, or electronic outputs or displays thereof.

As further used herein, the term “train,” when referring to training a machine learning model, may mean training an untrained model, further training a previously trained model, fine-tuning a pretrained model, or the like. “Train” is intended to broadly cover methods of machine learning using a dataset.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the foregoing description include the following:
Aspect 1: One or more computer storage media storing computer-readable instructions thereon that when executed by a processor, cause the processor to perform operations comprising: accessing a unique string; hashing the unique string to determine a hash value; and generating a unique font file version of a font file for a font by modifying a font table in accordance with the hash value.
Aspect 2: Aspect 1, wherein text rendered using the unique font file version comprises a spacing pattern for the font that is specific to the unique font file version.
Aspect 3: Aspect 2, wherein the spacing pattern within the text rendered from the unique font file version comprises glyph adjustments to at least one of a glyph width and glyph height, and the spacing pattern is determined from the hash value.
Aspect 4: Any of Aspects 1-3, further comprising providing access to the unique font file version such that text rendered using the unique font file version encodes at least a portion of the hash value in a spacing pattern.
Aspect 5: Any of Aspects 1-4, further comprising: identifying a font included in a markup language being accessed by a computing device corresponding to the unique string; and modifying the markup language to include an address of the unique font file version such that text is rendered using the unique font file version when the computing device reads the modified markup language.
Aspect 6: Any of Aspects 1-5, wherein modifying the font table includes modifying at least one of a horizontal metrics table that determines a glyph width, and a kerning table that determines spacing between specific pairs of glyphs.
Aspect 7: Any of Aspects 1-6, wherein: the hash value comprises a sequence of binary digits; at least one binary digit value corresponds to a glyph adjustment; and the font table is modified by adjusting font table values according to the sequence of binary digits so that glyphs are rendered with the glyph adjustment.
Aspect 8: Any of Aspects 1-6, wherein: the hash value comprises a sequence of binary digits; a first binary digit value corresponds to a first glyph adjustment for an increase in glyph spacing; and a second binary digit value corresponds to a second glyph adjustment for a decrease in glyph spacing.
Aspect 9: Any of Aspects 1-6, wherein: the hash value comprises a sequence of binary digits; at least one binary digit value corresponds to a glyph adjustment; the font table being modified corresponds to a kerning table that determines spacing between specific pairs of glyphs; and the font table is modified by adjusting font table values according to the sequence of binary digits so that the spacing between the specific pairs of glyphs is rendered with the glyph adjustment.
Aspect 10: A computer-implemented method comprising: hashing a string to generate a hash value; generating a unique font file version of a font file for a font by modifying a font table in accordance with the hash value; rendering text comprising a spacing pattern for the font that is specific to the unique font file version; and training a text classifier using the rendered text such that the trained text classifier classifies glyph adjustments within the spacing pattern.
Aspect 11: Aspect 10, further comprising labeling the rendered text with labels indicating the glyph adjustments, wherein the text classifier is trained using the labeled text.
Aspect 12: Any of Aspects 10-11, wherein the glyph adjustments within the spacing pattern of the rendered text comprise adjustments to at least one of a glyph width and glyph height.
Aspect 13: Any of Aspects 10-12, wherein: the hash value comprises a sequence of binary digits; at least one binary digit value corresponds to a glyph adjustment; and the font table is modified by adjusting font table values according to the sequence of binary digits so that glyphs within the text are rendered with the glyph adjustment.
Aspect 14: Any of Aspects 10-12, wherein: the hash value comprises a sequence of binary digits; a first binary digit value corresponds to a first glyph adjustment for an increase in glyph spacing; and a second binary digit value corresponds to a second glyph adjustment for a decrease in glyph spacing.
Aspect 15: Any of Aspects 10-12, wherein: the hash value comprises a sequence of binary digits; at least one binary digit value corresponds to a glyph adjustment; the font table being modified corresponds to a kerning table that determines spacing between specific pairs of glyphs; and the font table is modified by adjusting font table values according to the sequence of binary digits so that the spacing between the specific pairs of glyphs within the text is rendered with the glyph adjustment.
Aspect 16: A system comprising: at least one processor; and one or more computer storage media storing computer-readable instructions thereon that when executed by the at least one processor, cause the at least one processor to perform operations comprising: executing a text classifier on an artifact comprising text generated using a unique font file version, the text classifier classifying a relative size of glyph spacing; determining a data sequence from the classified relative sizes; identifying a hash value using the data sequence; and determining a source of the artifact based on the hash value, wherein the source is associated with the unique font file version.
Aspect 17: Aspect 16, further comprising: determining a font type of the text within the artifact; and selecting the text classifier based on the font type.
Aspect 18: Any of Aspects 16-17, wherein: the text classifier assigns a binary digit value to glyphs in the text based on the relative size of the glyph spacing; at least one binary digit value indicates a relative increase in the glyph spacing or a relative decrease in the glyph spacing; and the data sequence comprises a sequence of binary digits having the binary digit values.
Aspect 19: Any of Aspects 16-17, wherein: the text classifier assigns a binary digit value to glyphs in the text based on the relative size of the glyph spacing; a first binary digit value indicates a relative increase in the glyph spacing; a second binary digit value indicates a relative decrease in the glyph spacing; and the data sequence comprises a sequence of binary digits having the binary digit values.
Aspect 20: any of Aspects 16-19, wherein the hash value is identified from among a plurality of hash values, each hash value associated with a different unique font file version of a font file.
Aspect 21: Aspect 20, wherein the hash value is identified from among the plurality of hash values using a Pearson correlation.
Aspect 22: A system comprising: at least one processor; and one or more computer storage media storing computer-readable instructions thereon that when executed by the at least one processor, cause the at least one processor to perform operations comprising: receiving inputs to generate text having a font; accessing a unique font file version of a font file for the font, the unique font file version comprising a modified font table, wherein modifications within a font table correspond to a hash value generated from a unique string; and rendering the text having a spacing pattern that is specific to the unique font file version.
Aspect 23: Aspect 22, wherein the spacing pattern comprises glyph adjustments to at least one of a glyph width and glyph height.
Aspect 24: Any of Aspects 22-23, wherein the spacing pattern encodes at least a portion of the hash value in the text.
Aspect 25: Any of Aspects 22-24, wherein the text is rendered based on reading a markup language; and the unique font file version is accessed using an address included in the markup language.
Aspect 26: Any of Aspects 22-25, wherein the modified font table comprises at least one of a horizontal metrics table that determines a glyph width and a kerning table that determines spacing between specific pairs of glyphs.
Aspect 27: Any of Aspects 22-26, wherein: the hash value comprises a sequence of binary digits; at least one binary digit value corresponds to a glyph adjustment; and the spacing pattern of the text comprises glyphs that are rendered with the glyph adjustment.
Aspect 28: Any of Aspects 22-26, wherein: the hash value comprises a sequence of binary digits; a first binary digit value corresponds to a first glyph adjustment for an increase in glyph spacing; a second binary digit value corresponds to a second glyph adjustment for a decrease in glyph spacing; and the spacing pattern of the text comprises glyphs having the first glyph adjustment and the second glyph adjustment.
Aspect 29: Any of Aspects 22-28, wherein the modified font table corresponds to a kerning table that determines spacing between specific pairs of glyphs.

What is claimed is:

1. One or more computer storage media storing computer-readable instructions thereon that when executed by a processor, cause the processor to perform operations comprising:
accessing a unique string;
hashing the unique string to determine a hash value; and
generating a unique font file version of a font file for a font by modifying a font table in accordance with the hash value.

2. The media of claim 1, wherein text rendered using the unique font file version comprises a spacing pattern for the font that is specific to the unique font file version.

3. The media of claim 2, wherein the spacing pattern within the text rendered from the unique font file version comprises glyph adjustments to at least one of a glyph width and glyph height, and the spacing pattern is determined from the hash value.

4. The media of claim 1, further comprising providing access to the unique font file version such that text rendered using the unique font file version encodes at least a portion of the hash value in a spacing pattern.

5. The media of claim 1, further comprising:
identifying a font included in a markup language being accessed by a computing device corresponding to the unique string; and
modifying the markup language to include an address of the unique font file version such that text is rendered using the unique font file version when the computing device reads the modified markup language.

6. The media of claim 1, wherein modifying the font table includes modifying at least one of a horizontal metrics table that determines a glyph width, and a kerning table that determines spacing between specific pairs of glyphs.

7. The media of claim 1, wherein:
the hash value comprises a sequence of binary digits;
at least one binary digit value corresponds to a glyph adjustment; and
the font table is modified by adjusting font table values according to the sequence of binary digits so that glyphs are rendered with the glyph adjustment.

8. The media of claim 1, wherein:
the hash value comprises a sequence of binary digits;
a first binary digit value corresponds to a first glyph adjustment for an increase in glyph spacing; and
a second binary digit value corresponds to a second glyph adjustment for a decrease in glyph spacing.

9. The media of claim 1, wherein:
the hash value comprises a sequence of binary digits;
at least one binary digit value corresponds to a glyph adjustment;
the font table being modified corresponds to a kerning table that determines spacing between specific pairs of glyphs; and
the font table is modified by adjusting font table values according to the sequence of binary digits so that the spacing between the specific pairs of glyphs is rendered with the glyph adjustment.

10. A computer-implemented method comprising:
hashing a string to generate a hash value;
generating a unique font file version of a font file for a font by modifying a font table in accordance with the hash value;
rendering text comprising a spacing pattern for the font that is specific to the unique font file version; and
training a text classifier using the rendered text such that the trained text classifier classifies glyph adjustments within the spacing pattern.

11. The computer-implemented method of claim 10, further comprising labeling the rendered text with labels indicating the glyph adjustments, wherein the text classifier is trained using the labeled text.

12. The computer-implemented method of claim 10, wherein the glyph adjustments within the spacing pattern of the rendered text comprise adjustments to at least one of a glyph width and glyph height.

13. The computer-implemented method of claim 10, wherein:
the hash value comprises a sequence of binary digits;
at least one binary digit value corresponds to a glyph adjustment; and
the font table is modified by adjusting font table values according to the sequence of binary digits so that glyphs within the text are rendered with the glyph adjustment.

14. The computer-implemented method of claim 10, wherein:
the hash value comprises a sequence of binary digits;
a first binary digit value corresponds to a first glyph adjustment for an increase in glyph spacing; and
a second binary digit value corresponds to a second glyph adjustment for a decrease in glyph spacing.

15. The computer-implemented method of claim 10, wherein:
the hash value comprises a sequence of binary digits;
at least one binary digit value corresponds to a glyph adjustment;
the font table being modified corresponds to a kerning table that determines spacing between specific pairs of glyphs; and
the font table is modified by adjusting font table values according to the sequence of binary digits so that the spacing between the specific pairs of glyphs within the text is rendered with the glyph adjustment.

16. A system comprising:
at least one processor; and
one or more computer storage media storing computer-readable instructions thereon that when executed by the at least one processor, cause the at least one processor to perform operations comprising:
executing a text classifier on an artifact comprising text generated using a unique font file version, the text classifier classifying a relative size of glyph spacing;
determining a data sequence from the classified relative sizes;
identifying a hash value using the data sequence; and
determining a source of the artifact based on the hash value, wherein the source is associated with the unique font file version.

17. The system of claim 16, further comprising:
determining a font type of the text within the artifact; and
selecting the text classifier based on the font type.

18. The system of claim 16, wherein:
the text classifier assigns a binary digit value to glyphs in the text based on the relative size of the glyph spacing;
at least one binary digit value indicates a relative increase in the glyph spacing or a relative decrease in the glyph spacing; and
the data sequence comprises a sequence of binary digits having the binary digit values.

19. The system of claim 16, wherein:
the text classifier assigns a binary digit value to glyphs in the text based on the relative size of the glyph spacing;
a first binary digit value indicates a relative increase in the glyph spacing;
a second binary digit value indicates a relative decrease in the glyph spacing; and
the data sequence comprises a sequence of binary digits having the binary digit values.

20. The system of claim 16, wherein the hash value is identified from among a plurality of hash values using a Pearson correlation, each hash value associated with a different unique font file version of a font file.
